(19) United States
(12) Patent Application Publication
(10) Pub. No.: US 2014/0067437 A1
(43) Pub. Date: Mar. 6, 2014

(54) BOOKING MANAGEMENT METHOD FOR AMUSEMENT PARKS

(71) Applicant: Cheng-Wen CHANG, Hsinchu City (TW)

(72) Inventor: Cheng-Wen CHANG, Hsinchu City (TW)

(21) Appl. No.: 13/603,980

(22) Filed: Sep. 5, 2012

(51) Int. Cl. G06Q 10/02

(52) U.S. Cl. 705/5

(57) ABSTRACT

A booking management method for amusement parks determine if a facility is bookable or not at first. If the facility is bookable, visitors can book the facility via a device in the amusement park, such as a handheld device. Then they can more around anywhere in the amusement park until they obtain an admission message. When the visitor obtains the admission message, the visitor can go to the facility. Therefore, this booking management system is a fantastic way to reduce waiting time and can maximize visitors enjoyment of their visit.

### BACKGROUND OF THE INVENTION

1. Field of the Invention

The present invention relates to a booking management method, and more particular to a booking management method for amusement parks.

2. Description of Related Art

During the holiday periods, popular amusement parks are always crowed. Visitors want to use all of the amusement facilities, watch the shows and shop in the souvenir stores all in a limited time. However, the visitors have to wait in line for a long time before they use the popular facilities. During waiting, visitors cannot leave the queue to do anything. Unfortunately, their visits don't meet their expectations. All in all, the visitors waste precious time waiting in line.

To avoid that the visitors spend too much time on a queue in person, a conventional queuing system may provide serial numbers to visitors. The visitors sequentially enter the facility based on their serial numbers. The queue of the serial numbers is regarded as a virtual queue. Hence, the visitors have to pay attention to the progresses of the serial numbers. And then the visitors can estimate a duration time. Instead of waiting for the certain facility in person, the visitors can do other interested activities until the duration time is up.

As time goes, the visitors' serial numbers are bumped ahead in the virtual queue. However, if the visitors inaccurately estimate the duration time, the visitor cannot go back to the facility in time. When the visitors go back to the facility too early, the visitors still wait in the queue in person. When the visitors go back to the facility too late, their serial numbers have been skipped. The visitors may miss the opportunity to enter the facility. Therefore, the visitors have to wait in the queue again and spend additional time for the certain facility.

### SUMMARY OF THE INVENTION

Responsive to the disadvantage that the visitors waste time waiting in the queue, an objective of the present invention is to provide a booking management method for amusement parks to solve the problem.

The booking management method for amusement parks comprises the following steps:

determining whether a management device generates an allow-to-book signal by a handheld device;

generating a booking requirement by the handheld device if the allow-to-book signal is generated;

sending the booking requirement from the handheld device to the management device;

generating a serial number by the management device after receiving the booking requirement from the handheld device, wherein the serial number is stored in a queuing database;

sending the serial number from the management device to the handheld device;

receiving and storing the serial number from the management device by the handheld device;

determining whether the management device allows a visitor to use a facility by the handheld device; and

informing the visitor by the handheld device to proceed the facility according to the serial number.

Another booking management method for amusement parks comprises the following steps:

determining a whether a server generates an allow-to-book signal by a handheld device;

generating a booking requirement by the handheld device if the allow-to-book signal is generated;

sending the booking requirement from the handheld device to the server;

generating a serial number by the server after receiving the booking requirement from the handheld device, wherein the serial number is stored in a queuing database;

sending the serial number from the server to the handheld device;

receiving and storing the serial number from the server by the handheld device;

determining whether a management device allows a visitor to use a facility by the handheld device; and

informing the visitor by the handheld device to proceed the facility according to the serial number.

Another booking management method for amusement parks comprises the following steps:

determining whether a management device generates an allow-to-book signal by a server;

generating a booking requirement by the server if the allow-to-book signal is generated;

sending the booking requirement from the server to the management device;

generating a serial number by the management device after receiving the booking requirement from the server, wherein the serial number is stored in a queuing database;

sending the serial number from the management device to the server;

receiving and storing the serial number from the management device by the server;

determining whether the management device allows a visitor to use a facility by the server; and

sending a command to a handheld device by the server to inform the visitor to proceed the facility.

Another booking management method for amusement parks comprises the following steps:

determining whether an action flag operates in a status “1” by a server;

receiving a booking requirement from a handheld device by the server when the action flag operates in the status “1”;

generating a serial number by the server after receiving the booking requirement from the handheld device, wherein the serial number is stored in a queuing database;

sending the serial number from the server to the handheld device;

determining whether a management device allows a visitor to proceed a facility by the server; and

sending a command to the handheld device to inform the visitor to proceed a facility by the server.

Hence, the visitors can use their handheld device or browse on the Internet to obtain the information about the queuing status of the facilities in the amusement park and further book seats for the facilities. The visitors can go anywhere until they receive messages that the facility is ready for them. The visitors may spend less time on queuing and can effectively use their time.

### BRIEF DESCRIPTION OF THE DRAWINGS

FIG. 1 is a block diagram of a first embodiment of an amusement park management system of the present invention;

FIG. 2 is a flow chart of a booking program executed in a handheld device;

FIG. 3 is a flow chart of a management program executed in a management device;

FIG. 4 is a flow chart of another management program executed in a management device;

FIG. 5 is a block diagram of a second embodiment of an amusement park management system of the present invention;

FIG. 6 is a flow chart of a booking program executed in a handheld device;

FIG. 7 is a flow chart of a management program executed in a server;

FIG. 8 is a flow chart of another management program executed in a server;

FIG. 9 is a block diagram of a third embodiment of an amusement park management system of the present invention;

FIG. 10 is a flow chart of a booking program executed in a server;

FIG. 11 is a block diagram of a fourth embodiment of an amusement park management system of the present invention; and

FIG. 12 is a flow chart of a booking program executed in a server.

### DETAILED DESCRIPTION OF THE PREFERRED EMBODIMENT

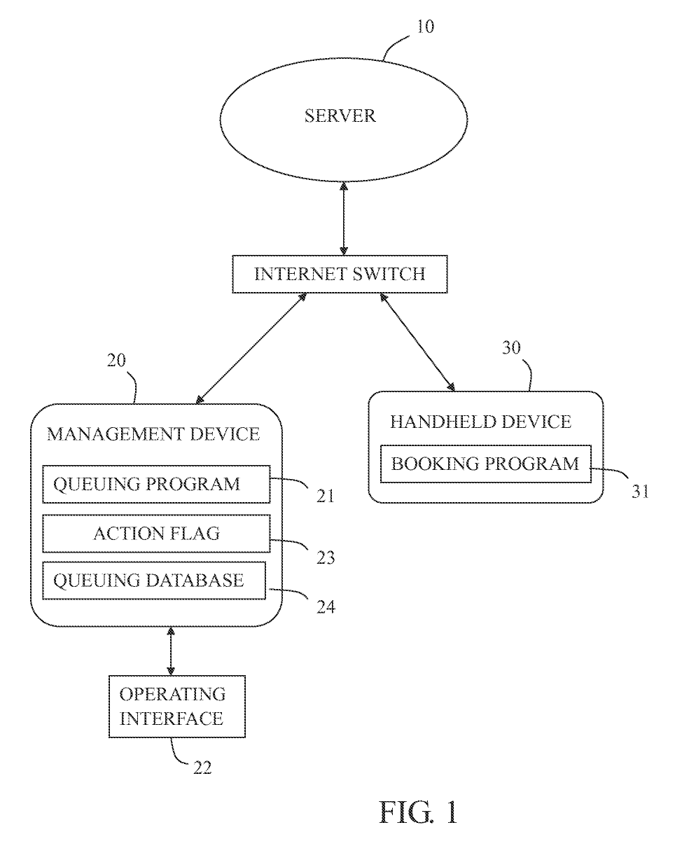

With reference to FIG. 1, an amusement park management system in accordance with the present invention comprises a server 10, multiple management devices 20 and multiple handheld devices 30.

The server 10 provides information about the facilities and communicates with the management devices 20 and the handheld devices 30. The information includes introductions, maps, show schedules, queuing status, lists of bookable facilities, etc.

Each of the management devices 20 is equipped in a service station of a facility and has an operating interface 22. An attendant working in the amusement park responsible for the facility can input commands to the management device 20 via the operating interface 22.

The handheld devices 30, such as mobile phones and tablet computers, are taken along with visitors. The visitors can browse the information and book the facilities by their handheld devices 30.

In a first embodiment of the present invention, the handheld device 30 executes a booking program 31 downloaded from the server 10. The management device 20 executes a queuing program 21 and has an operating interface 22 and a queuing database 24. When the management device 20 executes the queuing program 21, the queuing program 21 sets up an action flag 23 and controls the action flag 23 to operate in one of two statuses “0” or “1” based on the commands that the management device 20 receives from the operating interface 22.

For example, when the attendant determines that the facility is currently bookable, the attendant can input an allow-to-book command to the management device 20 via the operating interface 22 to change the status of the action flag 23 to “1”, and vise versa. The visitors can book seats of the facility by the handheld device 30.

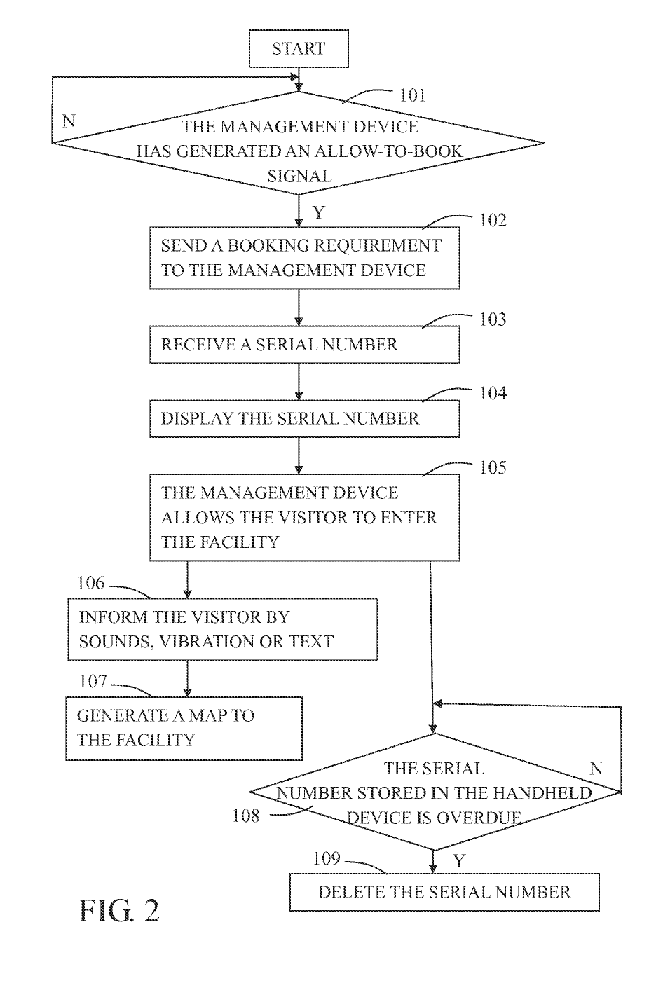

With reference to FIG. 2, for example, when a visitor operates the handheld device 30 to book the seat of the facility, the handheld device 30 determines whether the management device 20 has generated an allow-to-book signal or not (101). In this step, the handheld device 30 reads the status of the action flag 23 and determines the status “1” as the allow-to-book signal and the status “0” as a disallow-to-book signal.

If the handheld device 30 recognizes that the management device 20 has generated the allow-to-book signal, the handheld device 30 generates a booking requirement and sends the booking requirement to the management device 20 (102).

If the management device 20 accepts the booking requirement, the management device 20 generates a serial number, stores the serial number in the queuing database 24 and returns the serial number back to the handheld device 30. The handheld device 30 then receives and stores the serial number (103).

Otherwise, when a visitor goes to the service station for booking in person instead of using the handheld device 30, the attendant assists the visitor and operates the operating interface 22 to book a seat of the facility. The management device 20 also generates a corresponding serial number to the visitor. The queuing database 24 of the management device 20 stores the serial numbers in sequence. Because the visitor may book the facility through the handheld device 30 or the service station, the serial number can be represented by two different MAC address formats for distinguishing, wherein one is for the handheld device 30 and the other is for the service station.

If the handheld device 30 receives the serial number from the management device 20, which means that the booking action is accomplished, the handheld device 30 displays the serial number (104).

After the handheld device 30 receives the serial number from the management device 20, the handheld device 30 determines whether the management device 20 allows the visitors to enter the facility (105). The following paragraphs will introduce two cases that how the management device 20 allows the visitors to enter the facility.

A. Case 1:

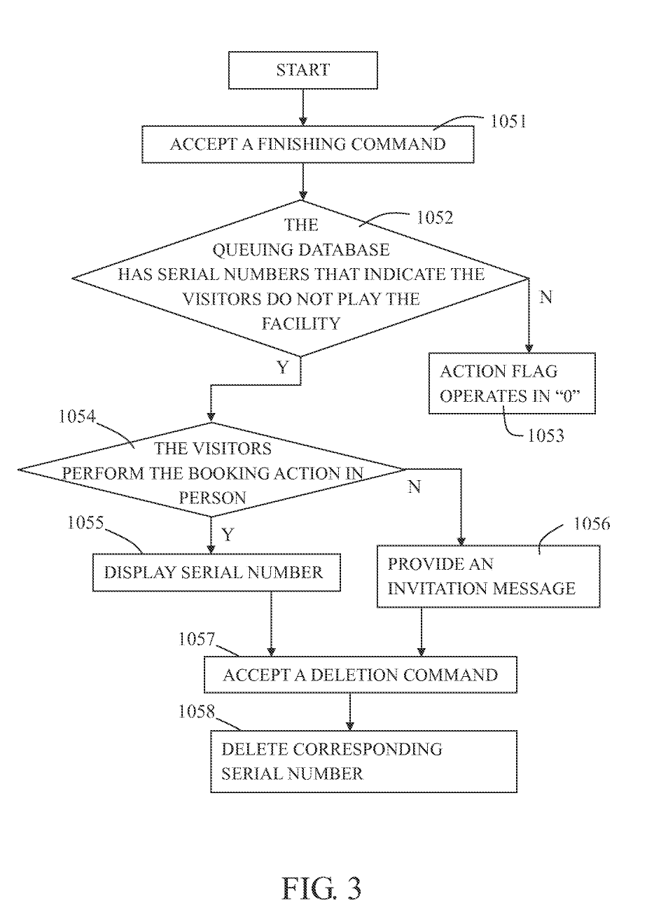

With reference to FIG. 3, when the attendant recognizes that the previous visitors have left and the facility is currently available, the attendant inputs a finishing command to the management device 20 via the operating interface 22. The management device 20 then accepts the finishing command at first (1051).

After accepting the finishing command, the management device 20 determines whether the queuing database 24 still reserves serial numbers. If the queuing database 24 has serial numbers, such serial numbers means there are visitors who do not play the facility (1052). When the visitors leave the facility, the management device 20 deletes the serial numbers from the queuing database 24. Therefore, the remaining serial numbers in the queuing database 24 are bumped ahead and correctly indicate the visitors who are waiting to play the facility.

If there is no serial numbers in the queuing database 24, which means the facility is available, the management device 20 changes the status of the action flag 23 to “0” (1053).

If the queuing database 24 still reserves serial numbers, the management device 20 selects earlier serial numbers from the queuing database 24 and determines whether the visitors perform the booking action through the handheld device 30 or the service station according to the MAC address format of the serial numbers (1054).

If the MAC address format of the serial number indicates that the visitor performs the booking action through the service station, the operating interface 22 displays the corresponding serial numbers (1055). Hence, when the attendant sees the serial numbers on the operating interface 22, the attendant can broadcast the information to invite the visitors at the facility.

If the MAC address format of the serial number indicates that the visitor performs the booking action by the handheld device 30, the management device 20 provides an invitation message and sends the invitation message to the handheld device 30 (1056). When the handheld device 30 receives the invitation message, the handheld device 30 recognizes that the management device 20 has allowed the visitors to use the facility.

When the visitors arrive at the facility, the visitors can enter the facility soon. When the attendant recognizes that the visitors finish playing the facility and leave the facility, the attendant inputs a deletion command to the management device 20 via the operating interface 22. When the management device 20 accepts the deletion command (1057), the management device 20 deletes the serial numbers of the visitors who have left the facility from the queuing database 24 (1058) and returns to the step (1051).

B. Case 2:

The handheld device 30 reads the current serial numbers from the queuing database 24 of the management device 20. As the previous visitors have left the facility, the subsequent serial numbers get bumped ahead in the queuing database 24. Therefore, the serial numbers in the queuing database 24 are continuously updated. If the serial number stored in the handheld device 30 approximates to the current serial numbers in the queuing database 24, the handheld device 30 recognizes that the management device 20 has allowed the visitors to use the facility.

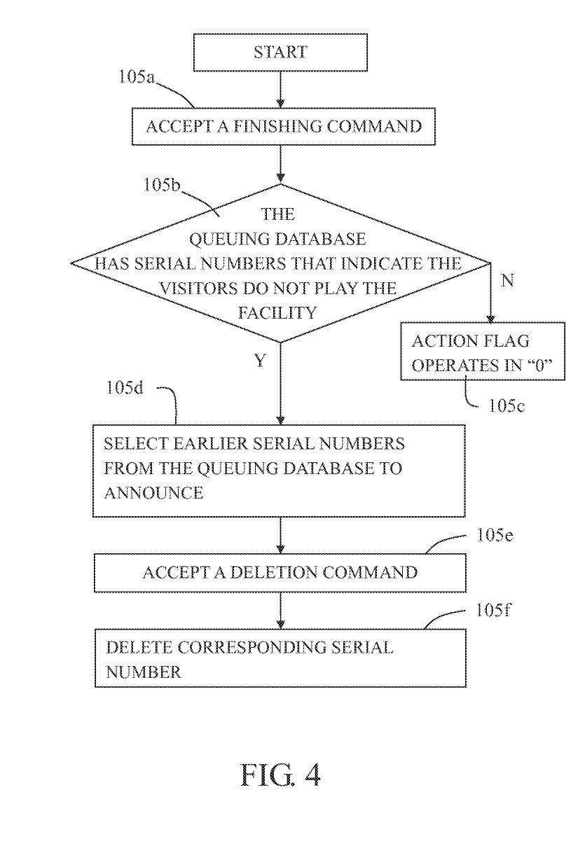

In the second case, with reference to FIG. 4, when the attendant determines that the previous visitors have left and the facility is currently available, the attendant inputs a finishing command to the management device 20 via the operating interface 22. The management device 20 then accepts the finishing command (105a).

After accepting the finishing command, the management device 20 determines whether the queuing database 24 still reserves serial numbers (105b).

If there is no serial numbers in the queuing database 24, the management device 20 changes the status of the action flag 23 to “0” (105c).

If the queuing database 24 still has serial numbers, the management device 20 selects earlier serial numbers from the queuing database 24 and announces the serial numbers on the Internet and a bulletin board at the facility (105d).

When the visitors arrive at the facility, the visitors can enter the facility soon. When the attendant recognizes that the visitors have played the facility and have left the facility, the attendant inputs a deletion command to the management device 20 via the operating interface 22. When the management device 20 accepts the deletion command (105e), the management device 20 deletes the serial numbers of the visitors who have left the facility from the queuing database 24 (105f) and returns to the step (105a).

If the handheld device 30 determines the management device 20 allows the visitors to use the facility, the handheld device 30 informs the visitors that it is time to play the facility by sounds, vibration or text (106), and the handheld device 30 may generate a map to indicate a path to a corresponding facility additionally (107). Furthermore, the server 10 may generate an identification message as a ticket to be sent to the handheld device 30 after the handheld device 30 receives the serial number from the management device 20. The visitors can show the identification message stored in the handheld device 30 to the attendant for accessing the facility.

Returning to FIG. 2, the handheld device 30 keeps reading the current serial numbers in the queuing database 24. The handheld device 30 determines whether the currently stored serial number is overdue or not by comparing the current serial numbers in the queuing database 24 with the serial number stored in the handheld device 30 (108).

If the serial number stored in the handheld device 30 is overdue, the serial number stored in the handheld device 30 is invalid. Hence, the handheld device 30 deletes the serial number and the map (109).

Furthermore, the server 10 calculates a number of the visitors who book a facility based on the serial numbers stored in the queuing database 24. If the number of the visitors is more than a threshold number, the server 10 sends a command to the management device 20 to change the status of the action flag 23 to “0” to avoid excessive visitors booking the facility.

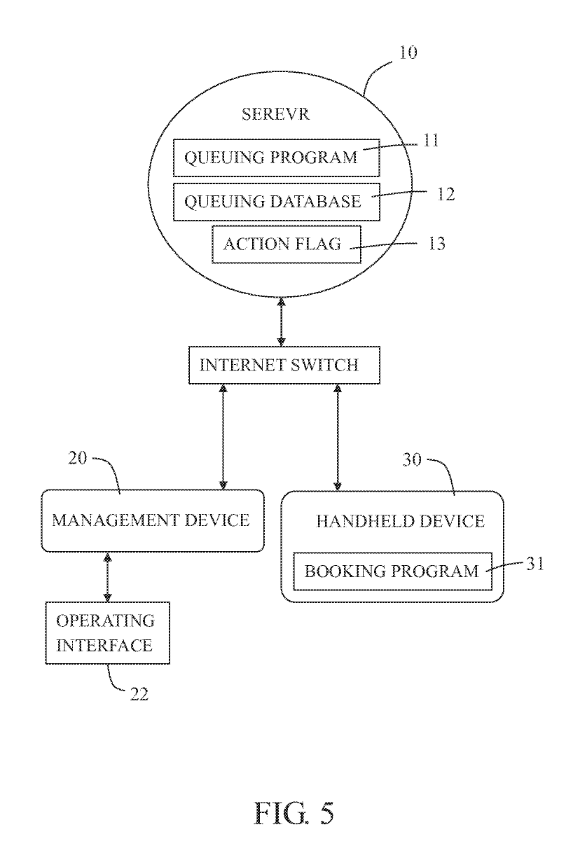

With reference to FIG. 5, in a second embodiment of the present invention, the handheld device 30 executes a booking program 31. The server 10 executes a queuing program 11 and has a queuing database 12. When the server 10 executes the queuing program 11, the queuing program 11 sets up an action flag 13 operating in one of the two statuses “0” or “1”, as mentioned in the first embodiment.

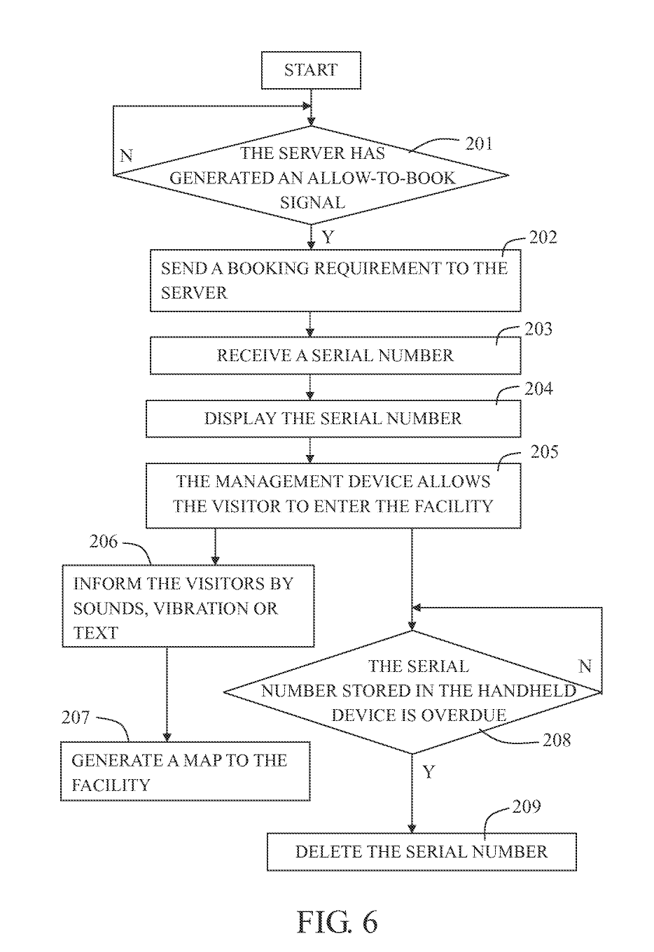

With reference to FIG. 6, the handheld device 30 communicates with the server 10 to read the status of the action flag 13. When a visitor uses the handheld device 30 to book a seat of the facility, the handheld device 30 determines whether the server 10 has generated an allow-to-book signal or not (201). The handheld device 30 interprets the status “1” as the allow-to-book signal and the status “0” as a disallow-to-book signal.

When the attendant determines that the facility is currently bookable, the attendant can input an allow-to-book command to the management device 20 via the operating interface 22. The management device 20 sends the allow-to-book command to the server 10. When the server 10 accepts the allow-to-book command, the server 10 changes the status of the action flag 13 to “1”.

If the handheld device 30 recognizes that the server 10 has generated the allow-to-book signal, the visitor can operate the handheld device 30 to generate a booking requirement. The handheld device 30 sends the booking requirement to the server 10 (202).

If the server 10 accepts the booking requirement, the server 10 generates a serial number and sends, stores the serial number in the queuing database 12 and returns the serial number back to the handheld device 30. The handheld device 30 then receives and stores the serial number (203).

Otherwise, when a visitor goes to the service station for booking in person instead of using the handheld device 30, the attendant assists the visitor and operates the operating interface 22 to book a seat of the facility. The management device 20 then sends a booking requirement the server 10. When the server 10 accepts the booking requirement sent from the management device 20, the server 10 also generates a corresponding serial number and returns the serial number back to the management device 20. Therefore, the queuing database 12 of the server 10 stores all of the serial numbers in sequence. The serial numbers, as mentioned in the first embodiment, comprise two MAC address formats that respectively correspond to the visitors who perform the booking action in person or by the handheld device 30.

If the handheld device 30 receives the serial number from the server 10, which means that the booking action is accomplished, the handheld device 30 displays the serial number (204).

After the handheld device 30 receives the serial number from the server 10, the handheld device 30 determines whether the management device 20 allows the visitors to enter the facility (205). The following paragraphs will introduce two cases that how the management device 20 allows the visitor to enter the facility.

A. Case 1:

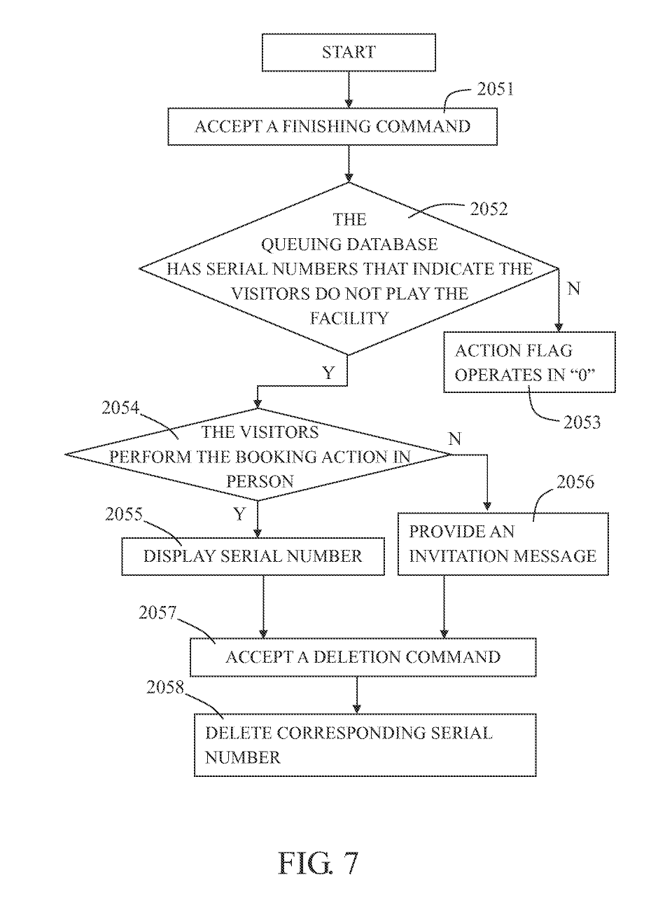

With reference to FIG. 7, when the attendant recognizes that the previous visitors have left and the facility is currently available, the attendant inputs a finishing command to the management device 20 via the operating interface 22. The management device 20 sends the finishing command to the server 10. The server 10 then accepts the finishing command at first (2051).

After accepting the finishing command, the server 10 determines whether the queuing database 12 still reserves serial numbers. If the queuing database 12 has serial numbers, such serial numbers means there are visitors do not play the facility (2052). When the visitors have left the facility, the server 10 deletes the serial numbers from the queuing database 12. Therefore, the remaining serial numbers in the queuing database 12 are bumped ahead and correctly indicate the visitors who are waiting to play the facility.

If there is no serial numbers in the queuing database 12, which means the facility is available, the server 10 changes the status of the action flag 13 to “0” (2053).

If the queuing database 12 still reserves serial numbers, the server 10 selects earlier serial numbers from the queuing database 12 and determines whether the visitors perform the booking action through the handheld device 30 or the service station according to the MAC address format of the serial numbers (2054).

If the MAC address format of the serial number indicates that the visitor performs the booking action through the service station, the server 10 informs the management device 20 of the serial numbers. The operating interface 22 of the management device 20 then displays the serial numbers (2055). Hence, when the attendant sees the serial numbers on the operating interface 22, the attendant can broadcast the information to invite the visitors.

If the MAC address format of the serial number indicates that the visitor performs the booking action by the handheld device 30, the server 10 provides an invitation message to the handheld device 30 (2056). When the handheld device 30 receives the invitation message, the handheld device 30 recognizes that the management device 20 has allowed the visitors to use the facility.

When the visitors arrive at the facility, the visitors can enter the facility soon. When the attendant recognizes that the visitors finish playing the facility and leave the facility, the attendant inputs a deletion command to the management device 20 via the operating interface 22. When the management device 20 accepts the deletion command, the management device 20 sends the deletion command to the server 10. When the server 10 accepts the deletion command (2057), the server 10 deletes the serial numbers of the visitors who have left the facility from the queuing database 12 (2058) and returns to the step (2051).

B. Case 2:

The handheld device 30 reads the current serial numbers from the queuing database 12 of the server 10. As the previous visitors have left the facility, the subsequent serial numbers get bumped ahead in the queuing database 12. Therefore, the serial numbers in the queuing database 12 are continuously updated. If the serial number stored in the handheld device 30 approximates to the current serial numbers in the queuing database 12, the handheld device 30 recognizes that the management device 20 has allowed the visitors to use the facility.

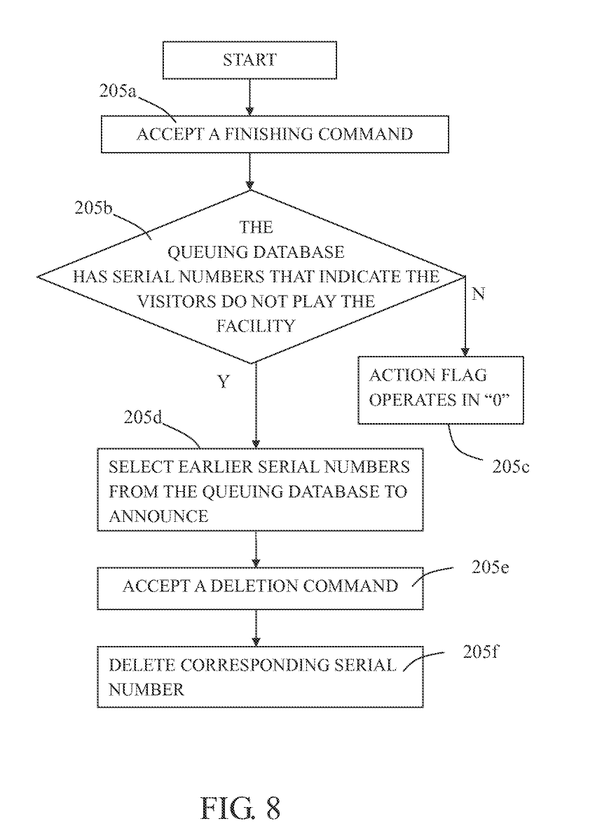

In the second case, with reference to FIG. 8, when the attendant determines that the previous visitors have left and the facility is currently available, the attendant inputs a finishing command to the management device 20 via the operating interface 22. The management device 20 sends the finishing command to the server 10. The server 10 then accepts the finishing command (205a).

After accepting the finishing command, the server 10 determines whether the queuing database 12 still reserves serial numbers (205b).

If there is no serial numbers in the queuing database 12, the server 10 changes the status of the action flag 13 to “0” (205c).

If the queuing database 12 still has serial numbers, the server 10 selects earlier serial numbers from the queuing database 12 and announces the serial numbers on the Internet and a bulletin board at the facility (205d).

When the visitors arrive at the facility, the visitors can enter the facility soon. When the attendant recognizes that the visitors have played the facility and have left the facility, the attendant inputs a deletion command to the management device 20 via the operating interface 22. When the management device 20 accepts the deletion command, the management device 20 sends the deletion command to the server 10. When the server 10 accepts the deletion command (205e), the server 10 deletes the serial numbers of the visitors who have left the facility from the queuing database 12 (205f) and returns to the step (205a).

If the handheld device 30 determines the management device 20 allows the visitors to use the facility, the handheld device 30 informs the visitors that it is time to go to the facility by sounds, vibration or text (206), and the handheld device 30 may further generate a map to indicate a path to a corresponding facility (207). Furthermore, the server 10 may generate an identification message as a ticket to be sent to the handheld device 30 after the handheld device 30 receives the serial number from the server 10. The visitors can show the identification message stored in the handheld device 30 to the attendant for accessing the facility.

Returning to FIG. 6, the handheld device 30 keeps reading the current serial numbers in the queuing database 12. The handheld device 30 determines whether the currently stored serial number is overdue or not by comparing the current serial numbers in the queuing database 12 with the serial number stored in the handheld device 30 (208).

If the serial number stored in the handheld device 30 is overdue, the serial number stored in the handheld device 30 will be invalid. Hence, the handheld device 30 deletes the serial number and the map (209).

Furthermore, the server 10 calculates a number of the visitors who book a facility based on the serial numbers stored in the queuing database 12. If the number of the visitors is more than a threshold number, the server 10 changes the status of the action flag 13 to “0” to avoid excessive visitors booking the facility.

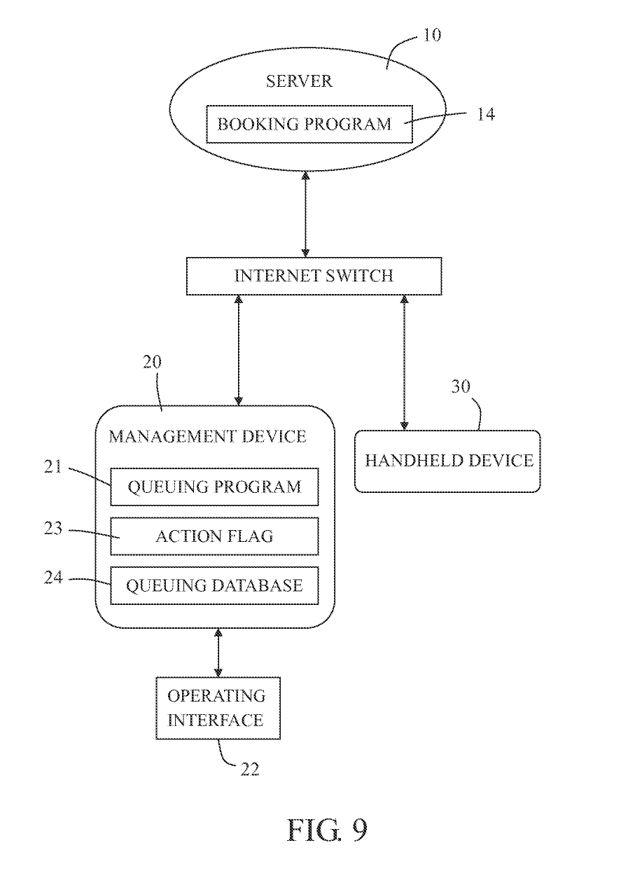

With reference to FIG. 9, in a third embodiment of the present invention, the server 10 executes a booking program 14. The management device 20 executes a queuing program 21 and has an operating interface 22 and a queuing database 24. When the management device 20 executes the queuing program 21, the queuing program 21 sets up an action flag 23 and controls the action flag 23 to operate in one of two statuses “0” or “1”.

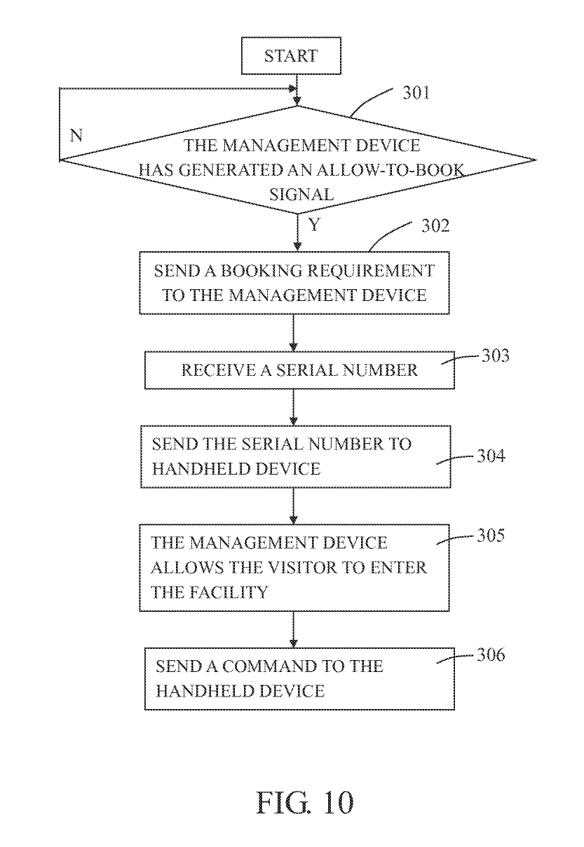

With reference to FIG. 10, the server 10 communicates with the management device 20 and the handheld device 30. The server 10 reads the status of the action flag 23 and serial numbers of the queuing database 24. A visitor can use the handheld device 30 to log in the server 10 to book a seat of the facility.

When the visitor operates the handheld device 30 to book a seat of the facility, the server 10 determines whether the management device 20 has generated an allow-to-book signal or not (301). The server 10 determines the status “1” as the allow-to-book signal and the status “0” as a disallow-to-book signal.

If the server 10 recognizes that the management device 20 has generated the allow-to-book signal, the visitor can operate the handheld device 30 to send a command to the server 10. When the server 10 accepts the command from the handheld device 30, the server 10 generates a booking requirement and sends the booking requirement to the management device 20 (302).

If the management device 20 accepts the booking requirement, the management device 20 generates a serial number, stores the serial number and returns the serial number back to the server 10. Hence, the server 10 then receives the serial number (303).

Otherwise, if a visitor goes to the service station for booking in person instead of using the handheld device 30, the attendant assists the visitor and operates the operating interface 22 to book a seat of the facility. The management device 20 also generates a corresponding serial number to the visitor. The queuing database 24 of the management device 20 stores the serial numbers in sequence. The serial numbers comprises two MAC address formats as mentioned in the first embodiment.

If the server 10 receives the serial number from the management device 20, which means that the booking action is accomplished, the server 10 sends the serial number to the handheld device 30 (304). When the handheld device 30 receives the serial number from the server 10, the handheld device 30 displays the serial number.

After the server 10 receives the serial number from the management device 20, the server 10 determines whether the management device 20 allows the visitors to enter the facility by two cases (305).

A. Case 1:

The first case is similar to the steps (1051)-(1058) of the first embodiment. Concisely, the management device 20 accepts a finishing command that indicates the facility is currently available. Then the management device 20 determines the queuing database 24 still reserves serial numbers. Then the management device 20 selects earlier serial numbers from the queuing database 24 and determines the MAC address format of the serial numbers. If the MAC address format of the serial number indicates that the visitor performs the booking action through the service station, the operating interface 22 displays the serial number. If the MAC address format of the serial number indicates that the visitor performs the booking action by the handheld device 30, the management device 20 provides an invitation message to the server 10. When the server 10 receives the invitation message, the server 10 recognizes the management device 20 has allowed the visitors to use the facility. Then the server 10 sends the invitation message to the handheld devices 30.

If the management device 20 accepts a deletion command indicating the visitors have left the facility, the management device 20 deletes the serial numbers from the queuing database 24.

B. Case 2:

The second case is similar to the steps (105a)-(105f) of the first embodiment. Concisely, the server 10 reads the serial numbers from the queuing database 24. If the serial number stored in the handheld device 30 approximates to the current serial numbers in the queuing database 24, the server 10 recognizes that the management device 20 has allowed the visitors to use the facility.

After the server 10 confirms the management device 20 has allowed the visitors to use the facility, the server 10 sends a command to the handheld device 30 (306). When the handheld device 30 receives the command from the server 10, the handheld device 30 informs the visitor that it is time to go to the facility by sounds, vibration or text. The handheld device 30 additionally generates a map to indicate a path to a corresponding facility.

Furthermore, the server 10 generates an identification message as a ticket to be sent to the handheld device 30 after the handheld device 30 receives the serial number. The visitors can show the identification message stored in the handheld device 30 to the attendant for accessing the facility.

The server 10 keeps reading the current serial numbers from the queuing database 24 of the management device 20. The server 10 determines whether the serial number of the handheld device 30 is overdue or not by comparing the current serial numbers in the queuing database 24 with the serial number stored in the handheld device 30.

If the serial number stored in the handheld device 30 is overdue, the serial number of the handheld device 30 is invalid. Hence, the server 10 orders the handheld device 30 to delete the serial number and the map.

Also, the server 10 calculates a number of the visitors based on the serial numbers stored in the queuing database 24. If the number of the visitors is more than a threshold number, the server 10 sends a command to the management device 20 to change the status of the action flag 23 to “0” to avoid excessive visitors booking the facility.

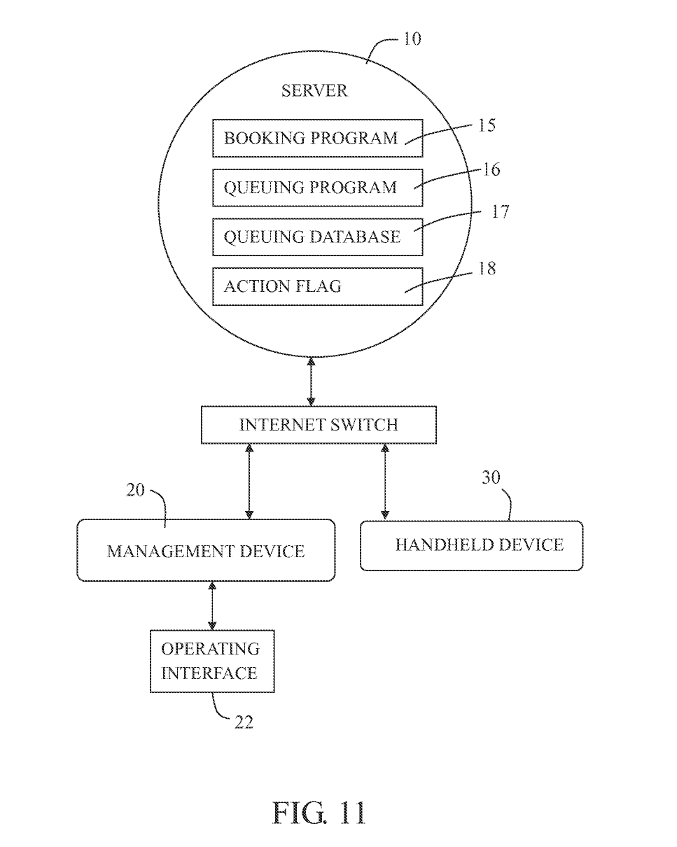

With reference to FIG. 11, in a fourth embodiment of the present invention, the server 10 communicates with the management device 20 and the handheld device 30. A visitor can perform the booking action through the service station or the handheld device 30. The server 10 executes a booking program 15 and the queuing program 16. The server 10 has the queuing database 17. When the queuing program 16 is executed, the queuing program 16 sets up an action flag 18 and controls the action flag 18 to operate in one of two statuses “0” or “1” as mentioned in the first embodiment.

When the attendant recognizes that facility is currently bookable, the attendant inputs an allow-to-book command to the management device 20 via the operating interface 22. When the management device 20 accepts the allow-to-book command, the management device 20 sends the allow-to-book command to the server 10. When the server 10 accepts the allow-to-book command, the server 10 changes the status of the action flag to “1”.

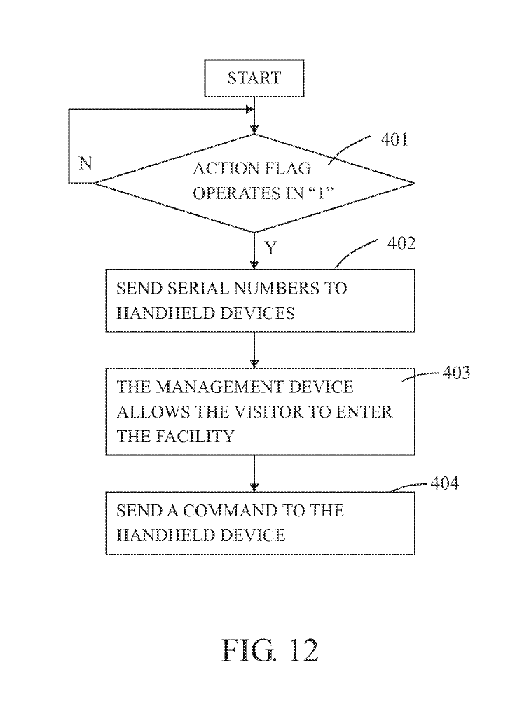

With reference to FIG. 12, first of all, the server 10 determines whether the action flag 18 operates in a status of “1” or not (401). The server 10 determines the status “1” as an allow-to-book signal and determines the status “0” as a disallow-to-book signal.

Assuming that a visitor performs the booking action by the handheld device 30, if the server 10 determines that the status of the action flag 18 is “1”, the server 10 generates a serial number, stores the serial number in the queuing database 17 and sends the serial number to the handheld device 30 (402).

Otherwise, if a visitor performs the booking action through the service station, the attendant operates the operating interface 22 to send a booking requirement to the management device 20. The management device 20 accepts the booking requirement and sends the booking requirement to the server 10. When the server 10 accepts the booking requirement, the server 10 also generates a serial number and stores the serial number in the queuing database 17. The queuing database 17 has serial numbers comprising two MAC address formats as mentioned in the first embodiment.

When the handheld device 30 receives the serial number from the server 10, the handheld device 30 displays the serial number.

After the server 10 sends the serial number to the handheld device 30, the server 10 determines whether the management device 20 allows the visitors to use the facility by two cases (403).

A. Case 1:

The first case is similar to the steps (2051)-(2058) of the second embodiment. Concisely, the management device 20 accepts a finishing command that represents the facility is currently available. Then the server 10 determines whether the queuing database 17 still reserves serial numbers. If the queuing database 17 still reserves serial numbers, the server 10 selects earlier serial numbers from the queuing database 17 and determines the MAC address format of the serial numbers.

If the MAC address format of the serial number indicates that the visitor performs the booking action through the service station, the server 10 orders the operating interface 22 of the management 20 to display the serial number. If the MAC address format of the serial number indicates that the visitor performs the booking action by the handheld device 30, the server 10 provides an invitation message, sends the invitation message to the handheld device 30 and recognizes the management device 20 has allowed the visitors to enter the facility.

If the server 10 accepts a deletion command that indicates the visitor has left the facility, the server 10 delete the serial number from the queuing database 17.

B. Case 2:

The second case is similar to the steps (205a)-(205f) of the second embodiment. Concisely, the server 10 reads the serial numbers from the queuing database 17. If the serial number stored in the handheld device 30 approximates to the current serial numbers in the queuing database 17, the server 10 recognizes that the management device 20 has allowed the visitors to use the facility.

After the server 10 confirms the management device 20 allows the visitor to use the facility, the server 10 sends a command to the handheld device 30 (404). When the handheld device 30 receives the command from the server 10, the handheld device 30 informs the visitors that it is time to go to the facility by sounds, vibration or text. The handheld device 30 additional generates a map to indicate a path to a corresponding facility.

Furthermore, the server 10 generates an identification message as a ticket to be sent to the handheld device 30 after the handheld device 30 receives the serial number from the server 10. The visitor can show the identification message stored in the handheld device 30 to the attendant for accessing the facility.

The server 10 may calculates a number of the visitors who book a facility based on the serial numbers stored in the queuing database 17. If the number of the visitors is more than a threshold number, the server 10 changes the status of the action flag 13 to “0” to avoid excessive visitors booking the facility. Based on the four embodiments of the present invention, the visitors can go to the facility when they receive the information that the facilities get ready. Before the facility is ready, the visitors can play the other facilities, watch shows or shop in the stores. The visitors can make use of their time effectively.

What is claimed is:

1. A booking management method for amusement parks comprising the following steps:
determining whether a management device generates an allow-to-book signal by a handheld device;
generating a booking requirement by the handheld device if the allow-to-book signal is generated;
sending the booking requirement from the handheld device to the management device;
generating a serial number by the management device after receiving the booking requirement from the handheld device, wherein the serial number is stored in a queuing database;
sending the serial number from the management device to the handheld device;
receiving and storing the serial number from the management device by the handheld device;
determining whether the management device allows a visitor to use a facility by the handheld device; and
informing the visitor by the handheld device to proceed the facility according to the serial number.

2. The booking management method as claimed in claim 1, wherein when the handheld device receives an invitation message from the management device, the handheld device determines that the management device allows the visitor to use the facility.

3. The booking management method as claimed in claim 1, wherein
when the serial number in the handheld device approximates to the serial numbers in the queuing database, the handheld device determines the management device allows the visitor to use the facility.

4. The booking management method as claimed in claim 2, wherein the handheld device receives an identification message from a server after the handheld device receives the serial number from the management device.

5. The booking management method as claimed in claim 3, wherein the handheld device receives an identification message from a server after the handheld device receives the serial number from the management device.

6. The booking management method as claimed in claim 4, wherein
when the handheld device receives the serial number from the management device, the handheld device displays the serial number.

7. The booking management method as claimed in claim 5, wherein
when the handheld device receives the serial number from the management device, the handheld device displays the serial number.

8. The booking management method as claimed in claim 6, wherein the handheld device informs the visitor to proceed the facility by sounds, vibration, text or a map that indicates a path to a facility.

9. The booking management method as claimed in claim 7, wherein the handheld device informs the visitor to proceed the facility by sounds, vibration, text or a map that indicates a path to a facility.

10. A booking management method for amusement parks comprising the following steps:
determining a whether a server generates an allow-to-book signal by a handheld device;
generating a booking requirement by the handheld device if the allow-to-book signal is generated;
sending the booking requirement from the handheld device to the server;
generating a serial number by the server after receiving the booking requirement from the handheld device, wherein the serial number is stored in a queuing database;
sending the serial number from the server to the handheld device;
receiving and storing the serial number from the server by the handheld device;
determining whether a management device allows a visitor to use a facility by the handheld device; and
informing the visitor by the handheld device to proceed the facility according to the serial number.

11. The booking management method as claimed in claim 10, wherein when the handheld device receives an invitation message from the server, the handheld device determines that the management device allows the visitor to use the facility.

12. The booking management method as claimed in claim 10, wherein
when the serial number in the handheld device approximates to the serial numbers in the queuing database, the handheld device determines the management device allows the visitor to use the facility.

13. The booking management method as claimed in claim 11, wherein the handheld device receives an identification message from the server after the handheld device receives the serial number from the server.

14. The booking management method as claimed in claim 12, wherein the handheld device receives an identification message from the server after the handheld device receives the serial number from the server.

15. The booking management method as claimed in claim 13, wherein
when the handheld device receives the serial number from the server, the handheld device displays the serial number.

16. The booking management method as claimed in claim 14, wherein
when the handheld device receives the serial number from the server, the handheld device displays the serial number.

17. The booking management method as claimed in claim 15, wherein the handheld device informs the visitor to proceed the facility by sounds, vibration, text or a map that indicates a path to a facility.

18. The booking management method as claimed in claim 16, wherein the handheld device informs the visitor to proceed the facility by sounds, vibration, text or a map that indicates a path to a facility.

19. A booking management method for amusement parks comprising the following steps:
determining whether a management device generates an allow-to-book signal by a server;
generating a booking requirement by the server if the allow-to-book signal is generated;
sending the booking requirement from the server to the management device;
generating a serial number by the management device after receiving the booking requirement from the server, wherein the serial number is stored in a queuing database;
sending the serial number from the management device to the server;
receiving and storing the serial number from the management device by the server;
determining whether the management device allows a visitor to use a facility by the server; and
sending a command to a handheld device by the server to inform the visitor to proceed the facility.

20. The booking management method as claimed in claim 19, wherein when the server receives an invitation message from the management device, the server recognizes the management device allows the visitor to proceed the facility.

21. The booking management method as claimed in claim 19, wherein
when the server receives the serial number from the management device, the server sends the serial number to the handheld device; and
when the serial number in the handheld device approximates to the serial numbers in the queuing database, the server determines the management device allows the visitors to proceed the facility.

22. The booking management method as claimed in claim 20, wherein
when the server receives the serial number from the management device, the server sends the serial number to the handheld device; and
the handheld device receives an identification message from the server after the handheld device receives the serial number from the server.

23. The booking management method as claimed in claim 21, wherein
when the server receives the serial number from the management device, the server sends the serial number to the handheld device; and
the handheld device receives an identification message from the server after the handheld device receives the serial number from the server.

24. The booking management method as claimed in claim 22, wherein
when the handheld device receives the serial number from the server, the handheld device displays the serial number.

25. The booking management method as claimed in claim 23, wherein
when the handheld device receives the serial number from the server, the handheld device displays the serial number.

26. The booking management method as claimed in claim 24, wherein the handheld device informs the visitor to proceed the facility by sounds, vibration, text or a map that indicates a path to a facility.

27. The booking management method as claimed in claim 25, wherein the handheld device informs the visitor to proceed the facility by sounds, vibration, text or a map that indicates a path to a facility.

28. A booking management method for amusement parks comprising the following steps:
determining whether an action flag operates in a status “1” by a server;
receiving a booking requirement from a handheld device by the server when the action flag operates in the status “1”;
generating a serial number by the server after receiving the booking requirement from the handheld device, wherein the serial number is stored in a queuing database;
sending the serial number from the server to the handheld device;
determining whether a management device allows a visitor to proceed a facility by the server; and
sending a command to the handheld device to inform the visitor to proceed a facility by the server.

29. The booking management method as claimed in claim 28, wherein the server provides an invitation message, sends the invitation message to the handheld device and recognizes the management device allows the visitors to proceed the facility

30. The booking management method as claimed in claim 28, wherein when the serial number in the handheld device approximates to the serial numbers in the queuing database, the server determines the management device allows the visitors to proceed the facility.

31. The booking management method as claimed in claim 29, wherein the server sends an identification message to the handheld device after the server sends the serial number to the handheld device.

32. The booking management method as claimed in claim 30, wherein the server sends an identification message to the handheld device after the server sends the serial number to the handheld device.

33. The booking management method as claimed in claim 31, wherein
when the handheld device receives the serial number from the server, the handheld device displays the serial number.

34. The booking management method as claimed in claim 32, wherein
when the handheld device receives the serial number from the server, the handheld device displays the serial number.

35. The booking management method as claimed in claim 33, wherein the handheld device informs the visitor to proceed the facility by sounds, vibration, text or a map that indicates a path to a facility.

36. The booking management method as claimed in claim 34, wherein the handheld device informs the visitor to proceed the facility by sounds, vibration, text or a map that indicates a path to a facility.
